(19) United States
(12) Patent Application Publication
(10) Pub. No.: US 2009/0323213 A1
(43) Pub. Date: Dec. 31, 2009

(54) SERVO SIGNAL RECORDING METHOD AND MAGNETIC DISK APPARATUS

(75) Inventor: Yoshiyuki Nanba, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/366,482

(22) Filed: Feb. 5, 2009

(30) Foreign Application Priority Data
Jun. 30, 2008 (JP) 2008-170482

(51) Int. Cl. G11B 5/09

(52) U.S. Cl. 360/39; G9B/5.033

(57) ABSTRACT

An MCU included in a magnetic disk apparatus determines, as a defective track, a track in which a servo signal abnormality is generated in a servo sector of the magnetic disk, and performs control to rewrite the servo signal to the defective track based on servo signal information for one round of a normal track in which the servo signal is normally written.

### CROSS-REFERENCE TO RELATED APPLICATIONS

This application is based upon and claims the benefit of priority of the prior Japanese Patent Application No. 2008-170482, filed on Jun. 30, 2008, the entire contents of which are incorporated herein by reference.

### FIELD

The embodiment discussed herein is related to a servo signal recording method and a magnetic disk apparatus which enable servo signals to be efficiently rewritten in a track of a magnetic disk.

### BACKGROUND

In recent years, the performance of a note type personal computer has been remarkably improved. As a result, it has become necessary to increase the capacity of a magnetic disk apparatus used in the personal computer. In recent years, a magnetic disk with a storage capacity of 1 TB has also been commercially produced, and it is expected that a magnetic disk apparatus will be further increased in capacity. Usually, a magnetic disk apparatus performs read/write processing of data by using a recording medium in which servo signals are recorded beforehand by using an apparatus, such as a servo track writer, capable of writing the servo signals in a plurality of media at a time. Thereby, the processing to write the servo signals in the magnetic disk apparatus is eliminated, and the number of assembling processing's and the assembling time are reduced.

Note that there is proposed a technique in which whether or not the width of a track formed to have a plurality of servo sectors with the servo signals recorded therein is normal is determined by using signals in burst regions of A, B, C and D included in each of the servo sectors, and in which when the width of the track is not normal, the track is processing as a defective track (see, for example, Japanese Laid-Open Patent Publication No. 2003-331545).

At present, as a write condition in the case of writing servo signals in a recording medium by a servo track writer, not an individual condition corresponding to each magnetic head of a magnetic disk apparatus and corresponding to each recording medium but a fixed condition is used. Therefore, when the recording medium is used by being incorporated into the magnetic disk apparatus, there is a case where the servo signals are unable to be read due to a difference in magnetic head characteristics and due to characteristic variation in the surface of the recording medium and so on. Usually, in the inspection processing at the time of assembling the magnetic disk apparatus, there is performed processing to inspect the servo signals on the whole surface of the recording medium and to determine a track/sector in which the servo signals cannot be normally read, as a defective track/sector, so as to prevent the use of the defective track/sector.

However, when the defective track/sector is frequently generated due to defective servo signals, and thereby, when a prescribed number or more of defective tracks/sectors are generated, a prescribed capacity of the magnetic disk apparatus cannot be secured, so that the magnetic disk apparatus becomes defective. When the magnetic disk apparatus becomes defective, it is necessary to perform work in which the magnetic disk apparatus is disassembled to take out the recording medium and in which the servo signals are rewritten in the recording medium by the servo track writer. Thus, the efficiency is significantly lowered in consideration of the replacement work of the recording medium and the time required to rerecord the servo signals.

### SUMMARY

The servo signal recording method of an embodiment of the present invention is a servo signal recording method for rewriting a servo signal to a disk in which a servo signal abnormality is generated. The servo signal recording method includes determining a track in which the servo signal abnormality is generated in a servo sector as a defective track, and rewriting a servo signal to the defective track based on servo signal information for one round of a normal track in which the servo signal is normally written.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram showing an example of a structure of a magnetic disk apparatus of a present embodiment;

FIGS. 2 and 3 are diagrams explaining an example of rewrite processing of servo signals;

FIG. 4 is a diagram showing a position eccentricity amount signal for one round of track of a magnetic disk; and

FIGS. 5 and 6 are diagrams showing a flow of rewrite processing of servo signals.

### DESCRIPTION OF EMBODIMENTS

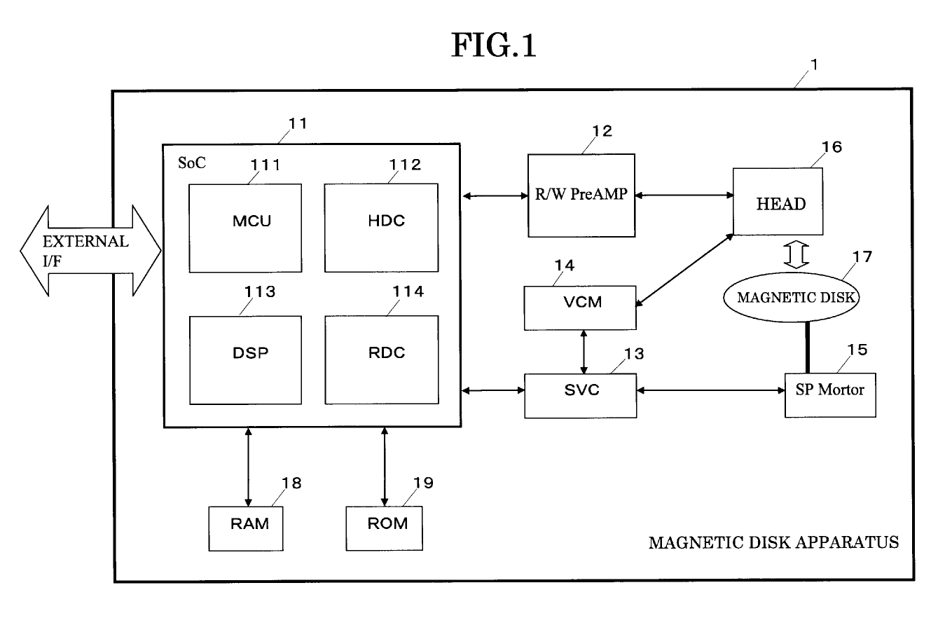

FIG. 1 is a diagram showing an example of a structure of a magnetic disk apparatus of a present embodiment. A magnetic disk apparatus 1 is a processing apparatus that rewrites servo signals in a disk in which a servo signal abnormality is generated. The magnetic disk apparatus 1 includes an SoC (System on Chip) 11, a write/read preamplifier (R/W PreAMP) 12, a servo controller (SVC) 13, a voice coil motor (VCM) 14, a spindle motor (SP Motor) 15, a head 16, a magnetic disk (Disk) 17, a RAM 18, and a ROM (Read Only Memory) 19.

The SoC 11 is configured such that LSIs such as an MCU (Micro Computer Unit) 111, an HDC (Hard Disk Controller) 112, a DSP (Digital Signal Processor) 113, and a RDC (Read Chanel) 114 are integrated by being collected into one LSI.

The MCU 111 controls each processing unit included in the magnetic disk apparatus 1, and also functions as a rewrite control unit to control servo signal rewrite processing to be performed by the magnetic disk apparatus 1 of the present embodiment. The MCU 111 reads an operation program of the magnetic disk apparatus 1 of the present embodiment. The operation program is stored beforehand in the ROM 19. Then, the MCU 111 performs read/write processing of data from/to the magnetic disk 17 via each of the LSIs in the SoC 11 and performs transmission/reception of data to/from a host computer (not illustrated) via an external I/F (interface). The HDC 112 writes data to the magnetic disk 17 and reads data from the magnetic disk 17 via the head 16 according to an instruction from the MCU 111. The RDC 114 performs analog/digital conversion of the data read by the head 16 from the magnetic disk 17. The DSP 113 performs an arithmetic operation for performing servo processing. The R/W PreAMP 12 performs signal conversion so that read data read by the head 16 and write data to be written to the disk via the head 16 can be easily processing in each of the LSIs included in the SoC 11. Further, the SVC 13 performs control of the VCM 14 and the SP Motor 15, in order to set the head 16 in an on-track state with respect to a target track of the magnetic disk 17. The VCM 14 moves the head 16 in the radial direction according to an instruction of the SVC 13. The SP Motor 15 controls rotation of the magnetic disk 17. Note that information (for example, track address and so on) on a defective track, which is determined to have a defective portion by servo signal verification processing performed by the MCU 111, as will be described below, is stored in the RAM 18.

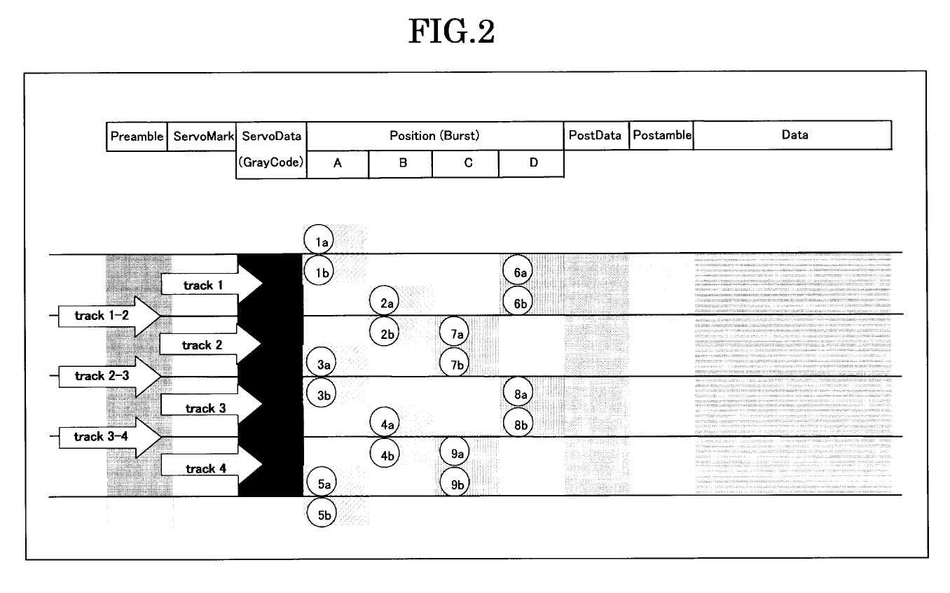

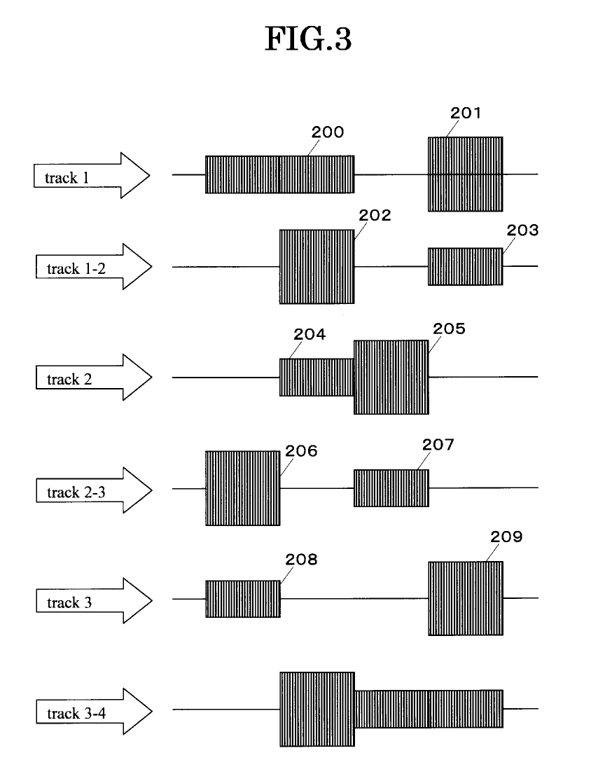

With reference to FIG. 2 and FIG. 3, there will be described an example of servo signal rewrite processing performed by the magnetic disk apparatus of the present embodiment.

Tracks 1, 2, 3 and 4 in FIG. 2 are tracks on the magnetic disk 17. A track 1-2 is the boundary position between the track 1 and the track 2. A track 2-3 is the boundary position between the track 2 and the track 3. A track 3-4 is the boundary position between the track 3 and tack 4. Further, Preamble, ServoMark, ServoData, Position (Burst), PostData, and Postamble illustrated in FIG. 2 are, as is well known, servo signals recorded in the servo area, and Data is user data. In the example illustrated in FIG. 2, the servo signals are recorded in each track by the servo writer.

Further, in the present embodiment, it is assumed that a plurality of servo sectors are provided on the magnetic disk 17, and the servo signals illustrated in FIG. 2 represent servo signals recorded on a certain specific servo sector. Further, reference characters 1a to 9b illustrated in FIG. 2 are Position signals included in the servo signals. The MCU 111 performs positioning of the head 16 based on the level of the Position signals.

FIG. 3 shows the levels of the Position signals read by the MCU 111 via the head 16 at the time when the head 16 is set at the positions of track 1, track 1-2, track 2, track 2-3, track 3 and track 3-4 in FIG. 2.

First, the magnetic disk 17 in which the servo signals illustrated in FIG. 2 are written is attached to the magnetic disk apparatus 1. Then, the MCU 111 inspects (performs servo signal verification processing on) whether or not the servo signals illustrated in FIG. 2 can be read. It is assumed that as a result of the servo signal verification processing, the servo signals of track 2 and track 3 cannot be read (a servo signal abnormality is generated). The MCU 111 temporarily registers the track 2 and the track 3 as defective tracks. Then, the MCU 111 rewrites the servo signals to the areas of the track 2 and the track 3 based on the servo signals for one round of an adjacent track in which the servo signals are normally written.

In the following, there will be described a procedure at the time of rewriting the servo signals.

(1) The MCU 111 offsets the head 16 by a predetermined amount in the direction of the track 1-2 in the state in which the head 16 is set in an on-track state with respect to the track 1. Thereby, the head 16 is set in an on-track state with respect to the track 1-2. When setting the head 16 in the on-track state with respect to the track 1, the MCU 111 positions the head 16 so as to make the level of a signal 200 illustrated in FIG. 3 become a half of the level of a signal 201. In this state, the MCU 111 writes the signals (2a, 2b) of the Position B. Since the servo signals are recorded in the magnetic disk 17 by the servo track writer, eccentric components for one round of the magnetic disk 17 after the magnetic disk 17 is attached to the magnetic disk apparatus 1, are included in the servo signals of the track 1 which serve as a reference at the time of writing the signals 2a and 2b. Since the signals 2a and 2b are written based on the servo signals for one round of the track 1, the eccentric components at the time of rewriting the servo signals can be made coincident with the eccentric components at the time of writing by the servo track writer.

(2) The MCU 111 positions the head 16 over the track 1-2 based on the position B (2a, 2b) and the Position D (6b) on the track 1-2. Specifically, the MCU 111 positions the head 16 so as to make the level of a signal 203 illustrated in FIG. 3 become a half of the level of a signal 202. In this state, the MCU 111 offsets the head 16 by a predetermined amount in the direction of the track 2, so as to set the head 16 in an on-track state with respect to the track 2. Then, the MCU 111 writes the signals (7a, 7b) of the Position C. At this time, when other signals, such as ServoMark, on the track 2 cannot be read, the MCU 111 also simultaneously writes the other signals.

(3) The MCU 111 positions the head 16 over the track 2 based on the Position B (2b) and the Position C (7a, 7b) on the track 2. Specifically, the MCU 111 positions the head 16 so as to make the level of a signal 204 illustrated in FIG. 3 become a half of the level of a signal 205. In this state, the MCU 111 offsets the head 16 by a predetermined amount in the direction of the track 2-3 so as to set the head 16 in an on-track state with respect to the track 2-3. Then, the MCU 111 writes the signals (3a, 3b) of the Position A.

(4) The MCU 111 positions the head 16 over the track 2-3 based on the Position A (3a, 3b) and the Position C (7b) on the track 2-3. Specifically, the MCU 111 positions the head 16 so as to make the level of a signal 207 illustrated in FIG. 3 become a half of the level of a signal 206. In this state, the MCU 111 offsets the head 16 in the direction of the track 3, so as to set the head 16 in an on-track state with respect to the track 3. Then, the MCU writes the signals (8a, 8b) of the Position D. At this time, when other signals on track 3, such as ServoMark, cannot be read, the MCU also simultaneously writes the other signals.

(5) The MCU 111 positions the head over the track 3. Specifically, the MCU 111 positions the head 16 so as to make the level of a signal 208 illustrated in FIG. 3 become a half of the level of a signal 209. In this state, the MCU 111 offsets the head 16 in the direction of the track 3-4, so as to set the head 16 in an on-track state with respect to the track 3-4, and writes the signals (4a, 4b) of the Position B.

Above described processing's of (1) to (5) represent a procedure of servo signal rewrite processing in a certain specific servo sector. The magnetic disk apparatus 1 of the present embodiment performs the servo signal rewrite processing to all the other servo sectors according to the same procedure. That is, the magnetic disk apparatus 1 collectively performs the servo signal rewrite processing for one track based on servo signals for one round of the adjacent track in which the servo signals are normally written.

Here, in the following, there will be described the reason why in the present embodiment, the rewrite processing is performed based on the servo signals for one round of the adjacent track in which the servo signals are normally recorded, while offsetting the head 16 from the position of the adjacent track.

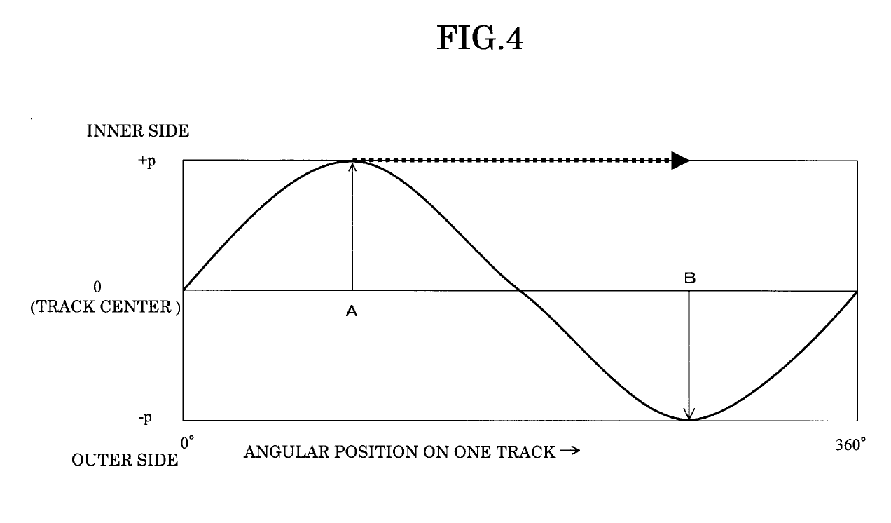

Before the magnetic disk apparatus is assembled, a servo track writer that is a dedicated apparatus used to write the servo signals writes the servo signals in the magnetic disk 17. Then, the magnetic disk 17 in which the servo signals are written is assembled to the spindle of the magnetic disk apparatus. At this time, the spindle center of the servo track writer is generally shifted from the spindle center of the magnetic disk apparatus. Therefore, a position eccentricity amount signal (signal representing the track eccentricity) for one round of track of the magnetic disk 17 after the magnetic disk 17 is attached to the magnetic disk apparatus comes to be in the state illustrated in FIG. 4. In FIG. 4, the horizontal axis represents the angular position on one track, and the vertical axis represents the eccentricity amount of the track. In the case where the servo signals are not normally written in a range from a position A to a position B in the state illustrated in FIG. 4, if servo signals are recorded along the dotted line arrow illustrated in FIG. 4 based on the position signals immediately before the position A, the servo signals are recorded at the position B in the state of being shifted by 2 p to the inner side (inside) as compared with the actual signals. This results in problems that the recorded position is deviated from the portion in which the servo signals are normally recorded, and that the signals are erroneously written in an adjacent track.

On the other hand, a method for writing the servo signals to the defective track by the magnetic disk apparatus 1 of the present embodiment, is performed based on one round of an adjacent track in which the servo signals are normally recorded. Therefore, servo signal rewrite processing is performed to the defective track in such a manner that the information on track eccentricity components obtained at the time of the recording by the servo track writer is taken over to the servo signal rewrite processing. As a result, even when the servo signals are rewritten, it is possible to secure the consistency with the track in which the servo signals are normally recorded, and hence it is possible to prevent the above described problem.

In the present embodiment, in the case where it is determined as a result of the servo signal verification processing that the number of continuously generated defective tracks is equal or more than a prescribed value, the continuity of address may not be able to be maintained, and hence the defective tracks are registered as tracks other than the object of the rewrite processing. This is to prevent the rewrite processing from being unlimitedly performed because the continuity of address may not be able to be maintained due to the write error that is caused by performing the rewrite processing. In the present embodiment, when there are, for example, one hundred or more defective tracks, the tracks are formally registered as defective tracks.

Further, another embodiment is featured in that after a first rewrite processing is performed to the defective track in the direction from the inside to the outside of the magnetic disk 17, or in the direction of the outside to the inside of the magnetic disk 17, it is determined whether or not the continuity of track address is maintained between the last track to which the rewrite processing is performed, and the next normal track, and in that when it is determined that the continuity of track address is not maintained, a second rewrite processing is performed from the next normal track in a reverse manner in the direction opposite to the direction of the first rewrite processing, until the continuity in track address with the track subjected to the first rewrite processing is maintained. According to another embodiment, the track pitch deviation is hardly caused. As a result, it is possible to reduce the track pitch error to about one-half as compared with the case where the rewrite processing is performed only in one direction.

According to the another embodiment, the MCU 111 sets an off-track slice value (allowable value of off-track amount) at the time of rewriting the servo signals to the defective track, to a value smaller than an off-track slice value at the time of writing the user data. As a result, it is possible to absorb the error amount that is caused by offsetting the head 16 by a predetermined amount in the rewrite processing. For example, it is preferred that the off-track slice value at the time of rewriting the servo signals be set to, for example, a value equal or less than 70% of the off-track slice value at the time of writing the user data.

Further, according to another embodiment, the MCU 111 sets the level of write current at the time of rewriting the servo signals to the defective track, to a level lower than a level of write current at the time of writing the data. The reason why the level of write current at the time of rewriting the servo signals is lowered, is that the servo signals written in the track adjacent to the track as the object of the rewrite processing are prevented from being overwritten and erased. The MCU 111 lowers the level of write current at the time of rewriting the servo signals, for example, by at least 10% or more from the level of write current at the time of writing the data.

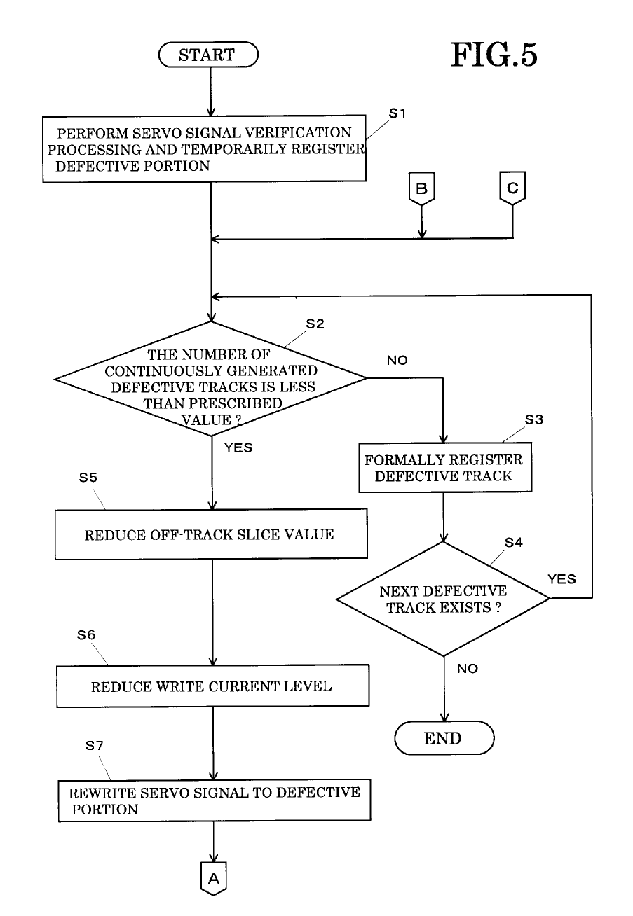

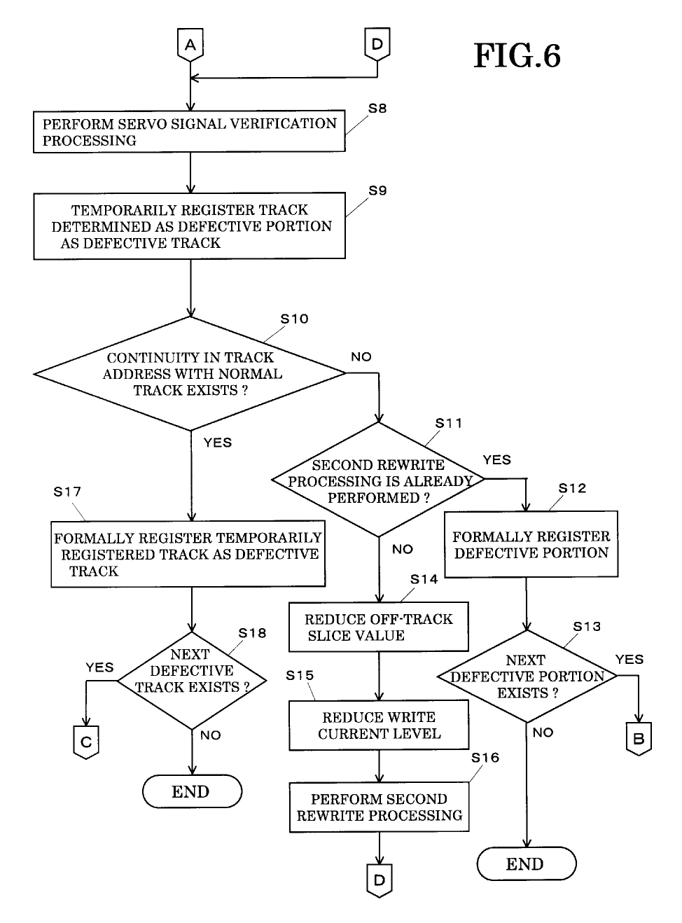

FIG. 5 and FIG. 6 are diagrams showing a flow of the servo signal rewrite processing performed by the magnetic disk apparatus according to the present embodiment.

The MCU 111 calls, from the ROM 19, the servo signal recording program used for rewriting the servo signals to the disk in which the servo signal abnormality is generated, and performs the rewrite processing according to the instruction of the program.

First, in step S1 in FIG. 5, the MCU 111 inspects (performs servo signal verification processing on) whether or not the servo signals on the whole surface of the magnetic disk 17 are correctly written. The MCU 111 determines, as a defective portion, a track in which the servo signals are not correctly written, and temporarily registers the defective portion in the RAM 18 (step S1). The MCU 111 temporarily registers, for example, the track address of the defective portion in the RAM 18.

When the defective portions are continuously generated, the MCU 111 determines whether or not the number of continuously generated defective tracks is smaller than a prescribed value (for example, 100 tracks) (step S2). When the MCU 111 determines that the number of continuously generated defective tracks is larger than the prescribed value, the MCU 111 formally registers, in the magnetic disk 17, the defective tracks as the tracks other than the track as the object of the rewrite processing (step S3). The MCU 111 determines whether or not a next defective portion is generated (step S4). When the MCU 111 determines that the next defective portion is generated, the processing returns to the step S2. When the MCU 111 determines that there is no defective portion, the processing ends.

In the case where the MCU 111 determines that the number of continuously generated defective tracks is smaller than the prescribed value in step S2, the MCU 111 instructs the DSP 113 to reduce the off-track slice value (step S5). The MCU 111 instructs that the off-track slice value is set to 70% of the off-track slice value at the time of writing the user data. The instruction given to the DSP 113 by the MCU 111 is transferred to the VCM 14 via the SVC 13, so that the off-track slice value is set.

Next, the MCU 111 instructs the HDC 112 to set the level of write current at the time of rewriting the servo signals to a level lower, for example, by 10% than the level of write current at the time of writing the user data (step S6). The HDC 112 sets the write current supplied to the head 16 via the R/W PreAMP 12 according to the instruction. Next, the MCU 111 rewrites the servo signals in the defective portions (step S7), and the processing proceeds to step S8 illustrated in FIG. 6.

In the step S8 in FIG. 6, the MCU 111 performs the servo signal verification processing to the portion subjected to the rewrite processing (step S8), and the MCU 111 temporarily registers the track, which is determined as a defective portion as a result of the servo signal verification processing, as a defective track in the RAM 18 (step S9).

Next, the MCU 111 determines whether or not the continuity of track address is maintained between the last track which is subjected to the servo signal rewrite processing and the next normal track which is not subjected to the servo signal rewrite processing (step S10). When the MCU 111 determines that the continuity of track address is not maintained, the MCU 111 determines whether or not the rewrite processing in the reverse direction (a second servo signal rewrite processing as will be described below) is already performed (step 511). When the MCU 111 determines that the rewrite processing in the reverse direction is already performed, the MCU 111 formally registers the defective portion including the track in which the continuity of track address is determined as not being maintained, as a defective portion in which the servo signals cannot be normally written (step S12). The MCU 111 determines whether or not another defective portion exists (step S13). When the MCU 111 determines that another defective portion exists, the processing returns to the step S2 in FIG. 5. When the MCU 111 determines that no defective portion exists, the processing ends.

When the MCU 111 determines in the step S11 that the write processing in the reverse direction is not performed, the MCU 111 reduces the off-track slice value (step S14) and reduces the level of write current (step S5). Then, the MCU 111 performs the second rewrite processing of the servo signals from the next normal track in a reverse manner in the opposite direction (step S16), and the processing returns to the step S8. In the step S16, the MCU 111 performs the second rewrite processing of the servo signals until the continuity in track address with the track subjected to the first rewrite processing can be maintained.

When the MCU 111 determines in the step S10 that the continuity of track address is maintained between the last track which is subjected to the rewrite processing of the servo signals, and the next normal track which is not subjected to the rewrite processing, the MCU 111 formally registers the track temporarily registered in the step S9, as a defective track in which the servo signals cannot be normally written (step S17). The MCU 111 determines whether or not another defective portion exists (step S18). When the MCU 111 determines that another defective portion exists, the processing returns to the step S2 in FIG. 5. When the MCU 111 determines that no defective portion exists, the processing ends.

It is understood that the magnetic disk apparatus of an embodiment of the present invention is a magnetic disk apparatus that performs servo signal rewrite processing to a disk in which a servo signal abnormality is generated. The magnetic disk apparatus comprises a rewrite control unit controlling to determine a track in which the servo signal abnormality is generated in a servo sector as a defective track, and controlling to rewrite a servo signal to the defective track based on servo signal information for one round of a normal track in which the servo signal is normally written.

The servo signal recording method and the magnetic disk apparatus of an embodiment register a track including a servo sector in which a servo signal abnormality is generated as a defective track, and rewrite servo signals to the defective track based on servo signal information for one round of a normal track in which the servo signals are normally written. Therefore, according to the servo signal recording method and the magnetic disk apparatus, when the servo signal abnormality occurs, it is possible to immediately rewrite the servo signal without the need to disassemble the magnetic disk apparatus so as to write the servo signals in the magnetic disk by using the servo track writer. Further, according to the servo signal recording method and the magnetic disk apparatus, the processing to rewrite the servo signals to the defective track can be performed in a state of taking over the eccentric component of the normal track. As a result, the servo signals can be efficiently rewritten in the track of the magnetic disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that the various changes, substitutions, and alterations could be made hereto without departing from the spirit and scope of the invention.

What is claimed is:

1. A servo signal recording method for rewriting a servo signal to a disk in which a servo signal abnormality is generated, comprising:
determining a track in which the servo signal abnormality is generated in a servo sector as a defective track, and rewriting a servo signal to the defective track based on servo signal information for one round of a normal track in which the servo signal is normally written.

2. The servo signal recording method according to claim 1,
wherein, after performing first rewrite processing to the defective track in the direction from the inside to the outside of the disk or in the direction from the outside to the inside of the disk, determining whether or not the continuity of track address is maintained between the last track subjected to the rewrite processing and a next normal track, and
wherein, when it is determined that the continuity of track address is not maintained, performing second rewrite processing from the next normal track in a reverse manner in the direction opposite to the direction of the first rewrite processing until the continuity in track address with the track subjected to the first rewrite processing is maintained.

3. The servo signal recording method according to claim 1, further comprises setting an off-track slice value at the time when the servo signal is rewritten to the defective track to a value lower than an off-track slice value at the time of writing user data.

4. The servo signal recording method according to claim 1, further comprises setting a level of write current at the time when the servo signal is rewritten to the defective track lower than a level at the time of writing data.

5. A magnetic disk apparatus that performs servo signal rewrite processing to a disk in which a servo signal abnormality is generated, comprising:
a rewrite control unit controlling to determine a track in which the servo signal abnormality is generated in a servo sector as a defective track, and controlling to rewrite a servo signal to the defective track based on servo signal information for one round of a normal track in which the servo signal is normally written.

6. The magnetic disk apparatus according to claim 5,
wherein, after the rewrite control unit performs first rewrite processing to the defective track in the direction from the inside to the outside of the disk or in the direction from the outside to the inside of the disk, the rewrite control unit determines whether or not the continuity of track address is maintained between the last track subjected to the rewrite processing and a next normal track, and
wherein, when the rewrite control unit determines that the continuity of track address is not maintained, the rewrite control unit performs second rewrite processing from the next normal track in a reverse manner in the direction opposite to the direction of the first rewrite processing until the continuity in track address with the track subjected to the first rewrite processing is maintained.

7. The magnetic disk apparatus according to claim 5, wherein the rewrite control unit sets an off-track slice value at the time when the servo signal is rewritten to the defective track to a value lower than an off-track slice value at the time of writing user data.

8. The magnetic disk apparatus according to claim 5, wherein the rewrite control unit sets a level of write current at the time when the servo signal is rewritten to the defective track lower than a level of write current at the time of writing data.
